(19) United States
(12) Patent Application Publication
(10) Pub. No.: US 2015/0177912 A1
(43) Pub. Date: Jun. 25, 2015

(54) Method and System for Contextual Update of Geographic Imagery

(71) Applicants: David Kornmann, Tuscon, AZ (US); Julien Charles Mercay, Belmont, CA (US)

(72) Inventors: David Kornmann, Tuscon, AZ (US); Julien Charles Mercay, Belmont, CA (US)

(21) Appl. No.: 13/729,946

(22) Filed: Dec. 28, 2012

(51) Int. Cl. G06F 3/0481

(52) U.S. Cl. CPC G06F 3/0481

(57) ABSTRACT

Methods and systems for presenting geographic imagery in conjunction with content detailing specific information about the geographic imagery are provided. More particularly, a user interface can present geographic imagery in conjunction with a display element, such as a text balloon, a text frame, or other element for presenting information to a user. The display element can provide content, such as text and other information, detailing specific information about the geographic imagery. As the user analyzes the information presented in the display element, for instance by scrolling through the information, the geographic imagery can be automatically updated based on the content provided in the display element. For instance, the geographic imagery can be updated with additional vectors, overlays, geographic data layers, camera views, etc., to display or highlight the information presented in the display element as the different aspects of the information come into focus in the display element.

### FIELD

The present disclosure relates generally to displaying geographic imagery, and more particularly, to providing contextual updates of geographic imagery based on information provided in a display element presented in conjunction with the geographic imagery.

### BACKGROUND

Geographic information systems provide for the archiving, retrieving, and manipulating of data that has been stored and indexed according to geographic coordinates of its elements. Interactive geographic information systems allow for the navigating and displaying of geographic imagery. Some interactive geographic information systems provide a user interface with navigation controls for navigating cities, neighborhoods, geographic areas and other terrain in two or three dimensions. Exemplary geographic information systems for navigating geographic imagery include the Google Earth™ virtual globe application and the Google Maps™ mapping service developed by Google Inc.

Geographic information systems can provide virtual tours of points of interest in the geographic information system. The virtual tour can include an animation or other sequence of events that automatically updates the view of the geographic imagery with vectors, overlays, geographic data layers, different camera views, etc. as the user progresses through the tour. A user can progress through the virtual tour, for instance, by interacting with hyperlinks presented in conjunction with virtual tour.

Information associated with the virtual tour, such as textual information detailing information about a particular location in the virtual tour, is often presented in conjunction with the geographic imagery as the virtual tour progresses. This information can be presented in the form of display elements (e.g. text balloons) that are presented in conjunction with the geographic imagery. As the virtual tour progresses, different display elements detailing information about different aspects of the virtual tour can be presented to the user. The changing shape and location of the display elements during the virtual tour can be distracting to a user.

### SUMMARY

Aspects and advantages of the invention will be set forth in part in the following description, or may be obvious from the description, or may be learned through practice of the invention.

One exemplary aspect of the present disclosure is directed to a computer-implemented method of presenting geographic imagery. The method includes presenting a first view of the geographic imagery in a user interface on a display of a computing device and providing a display element in conjunction with the geographic imagery. The display element provides content associated with the geographic imagery. The content includes a plurality of subsections. At least one of the content subsections is visible in the display element. The method further includes receiving a user input directed to the display element adjusting the visibility of one or more of the subsections in the display element. In response to the user input, the method includes performing operations. The operations include selecting a subsection displayed in the display element based on the visibility of the subsection; analyzing the selected subsection to identify one or more parameters; and adjusting the geographic imagery in the user interface to present a second view of the geographic imagery based on the identified parameters.

Other exemplary aspects of the present disclosure are directed to systems, apparatus, non-transitory computer-readable media, user interfaces and devices for providing the contextual update of geographic imagery based on content provided in a display element presented in conjunction with the geographic imagery.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an exemplary user interface presenting geographic imagery and a display element in accordance with an exemplary embodiment of the present disclosure;

FIG. 2 depicts a block diagram illustrating the contextual update of geographic imagery based on information presented in a display element according to an exemplary embodiment of the present disclosure;

FIG. 3 depicts a flow diagram of an exemplary method according to an exemplary embodiment of the present disclosure;

FIG. 4 depicts a flow diagram of an exemplary method for providing a virtual tour according to an exemplary embodiment of the present disclosure;

FIGS. 5A and 5B depict an exemplary user interface providing a virtual tour according to an exemplary embodiment of the present disclosure;

FIG. 6 depicts a flow diagram of an exemplary method for providing travel directions according to an exemplary embodiment of the present disclosure;

FIGS. 7A and 7B depict an exemplary user interface providing travel directions according to an exemplary embodiment of the present disclosure; and

FIG. 8 depicts an exemplary computer-based system according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

### Overview

Generally, the present disclosure is directed to methods and systems for presenting geographic imagery, such as three-dimensional geographic imagery, in conjunction with content detailing specific information about the geographic imagery. More particularly, a user interface can present geographic imagery in conjunction with a display element, such as a text balloon, a text frame, or other element for presenting information to a user. The display element can provide content, such as text and other information, detailing specific information about the geographic imagery. The information can include a plurality of subsections (e.g. paragraphs). Each subsection can include a different set of information associated with the geographic imagery.

As the user analyzes the information presented in the display element, for instance by scrolling through the subsections, the geographic imagery can be automatically updated based on the content provided in the subsections. For instance, the geographic imagery can be updated with additional vectors, overlays, geographic data layers, camera views, etc., to display or highlight the information presented in the different subsections as the different subsections come into focus in the display element. In this way, the information provided in the display element can be automatically augmented with visual information provided by the geographic imagery as the user reviews the information in the display element.

One exemplary application of the present disclosure is directed to virtual tours. In particular, a user interface can present a display element in conjunction with geographic imagery providing a three-dimensional representation of a geographic area. The display element can provide content detailing specific aspects of the virtual tour. For instance, the display element can provide information detailing different views, aspects, facts, or other information associated with a geographic area. The virtual tour can be driven by the user reviewing the content in the display element. In particular, the content can include a plurality of subsections with each subsection associated with a different part of the virtual tour. As a user scrolls or otherwise navigates through the different subsections in the display element, the geographic imagery can be updated to present differing views of the geographic area to highlight or augment the information contained in the different subsections as the different subsections come into focus in the user interface.

For example, a user can request a virtual tour relating to the ascension of Mount Everest. The user interface can present a display element providing information, such as a web document, in conjunction with geographic imagery associated with Mount Everest. The information can include a plurality of subsections (e.g. paragraphs), with each subsection detailing specific aspects of the ascension of Mount Everest, including, for instance: (1) Base Camp; (2) Khumbu Icefall; (3) the Hilary Step; (4) the Summit, etc. As the user scans through the subsections (e.g. scrolls through the web document) different subsections will come into focus in the display element. The geographic imagery can be automatically updated to present views associated with the information in each subsection. For instance, different camera views of Mount Everest can be provided to present the locations discussed in each subsection. In addition, information such as trekking paths, altitude, and other information can be presented to augment the information in each subsection.

Another exemplary application of the present disclosure is directed to travel directions. For instance, a user can request travel directions for a travel objective between an origin and a destination. The user interface can provide a display element outlining the different steps in the travel directions. The user interface can also present geographic imagery that displays and highlights a portion of the route provided by the travel directions. As the user scans through the travel directions in the display element, for instance by scrolling through the travel directions, the geographic imagery can be updated to display and highlight the specific steps provided in the travel directions.

### Contextual Update of Geographic Imagery

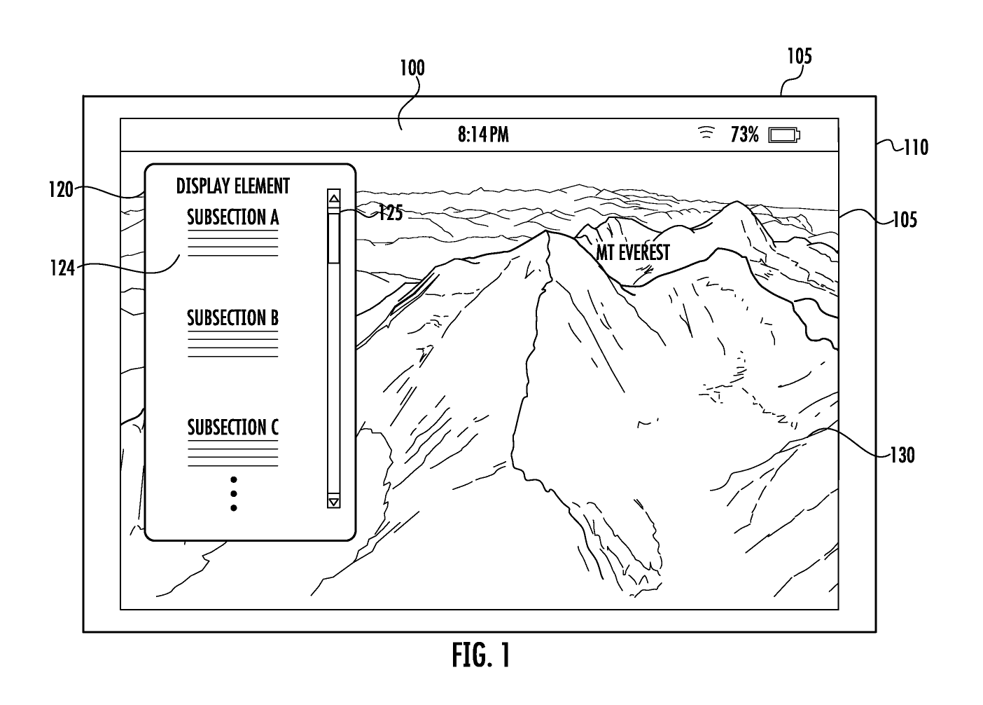

With reference now to the FIGS., exemplary embodiments of the present disclosure will now be discussed in detail. FIG. 1 depicts an exemplary user interface 100 for presenting geographic imagery 130. The user interface 100 can be provided by a geographic information system that allows a user to navigate geographic imagery, such as the Google Maps™ mapping services or Google Earth™ virtual globe application provided by Google Inc. The user interface 100 can be generated for presentation on a display 105 of a computing device 110, such as a smartphone, tablet, mobile phone, mobile device, desktop, laptop, or other suitable computing device.

The user interface 100 presents geographic imagery 130. The geographic imagery 130 can be two or three dimensional imagery of a geographic area of interest. In one example, the geographic imagery can be provided as part of a three dimensional model, such as part of a three dimensional model of the Earth. The user can navigate the geographic imagery 130 by navigating a virtual camera using various control tools or using various other user interactions, such as touch interactions on the display 105. For instance, a user can interact with the user interface 100 to pan, tilt, and zoom the geographic imagery 130.

The user interface 100 can present a display element 120 in conjunction with the geographic imagery 130. The display element 120 can be a text balloon, text frame, or other suitable element for providing information to a user. The size and location of the display element 120 can be adjusted by the user. The display element 120 can present content 124, such as text content and other information, associated with the geographic imagery 130. For instance, the display element 120 can present text detailing specific information about the geographic area or objects depicted in the geographic imagery 130. In one aspect, the content 124 can be a web document specified in a markup language, such as HTML, XML, or other suitable markup language. The web document can be a single page web document, a tabbed web document, or other suitable web document.

The content 124 can include a plurality of subsections. Each subsection can be associated with a different aspect of the geographic area or objects depicted in the geographic imagery 130. For instance, each subsection can be a different paragraph. Each paragraph can detail different aspects about the geographic area or objects depicted in the geographic area. The content 124 of FIG. 1 includes subsections that are visible in the display element 120, such as Subsection A, Subsection B, and Subsection C. The content 124 can also include subsections that are not visible in the display element 120, such as Subsection D, Subsection E, and so forth. A user can provide a user input directed to the display element 120 to adjust the visibility of the subsections in the display element 120 such that the non-visible subsections become visible. For instance, a user can provide a user input to the scroll tool 125 to scroll the content 124 in the display element 120 such that non-visible subsections become visible. A user can also adjust the visibility of the subsections, for instance, by scrolling the content 124 in the display element 120 using a finger swipe on a touch screen or other suitable user input. In the context of a tabbed web document, a user can adjust the visibility of the subsections, for instance, by navigating to different tabs of the web document.

According to particular aspects of the present disclosure, the view of the geographic imagery 130 can be updated based on the context of the content presented in the display element 120. For instance, as the user scrolls or navigates through the information presented in the display element, the view of the geographic imagery 130 can be updated with vectors, overlays, geographic data layers, different camera views, etc. to depict or highlight the information presented in the display element 120. In this manner, the user can control the geographic imagery 130 presented in the display element by navigating through the content 120 depicted in the display element 120.

For instance, in one embodiment, one of the subsections of the content 124 depicted in the display element 120 can be selected based on the visibility of the subsection in the display element 120. For instance, Subsection A can be selected as the most prominently visible subsection in the display element 120. The view of the geographic imagery 130 can present information associated the content of Subsection A. As the user scrolls or navigates through the content 124 in the display element 120, different subsections will become more prominently visible. For instance, Subsection B can be selected as the most prominently visible subsection in the display element 120. The view of the geographic imagery 130 can be automatically updated to present information associated with Subsection B. In this manner, the view of the geographic imagery 130 is driven by the context of the content 124 most likely being currently viewed by the user.

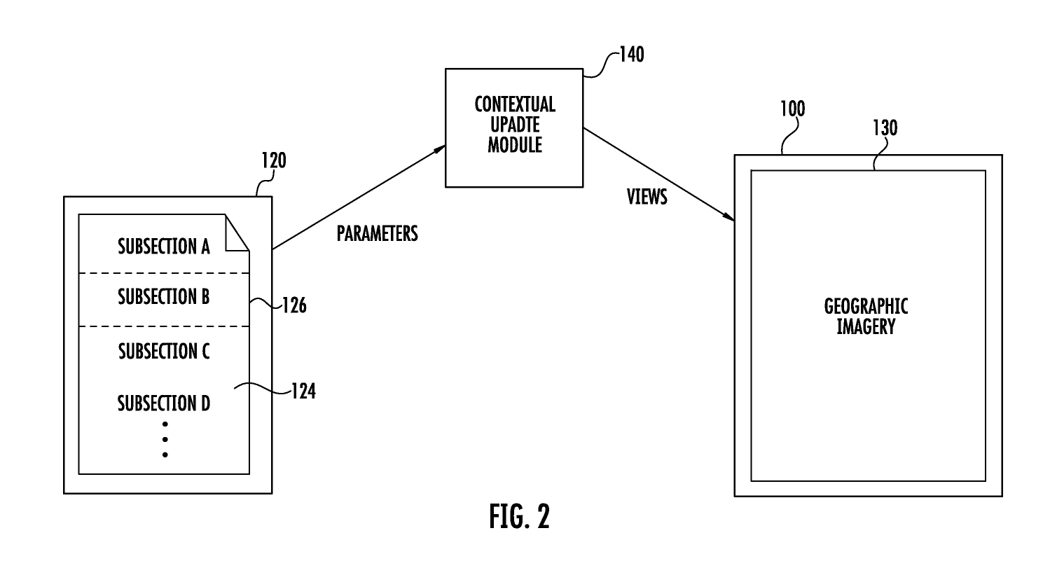

FIG. 2 depicts a block diagram illustrating the contextual update of geographic imagery based on information presented in a display element according to an exemplary embodiment of the present disclosure. In particular, the computing device 110 (shown in FIG. 1) can be configured to implement a contextual update module 140 to provide contextual updates of geographic imagery.

It will be appreciated that the term “module” refers to computer logic utilized to provide desired functionality. Thus, a module can be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, hard disk or optical or magnetic media.

The contextual update module 140 can be configured to analyze content 124 presented in the display element 120 and update the geographic imagery 130 presented in the user interface 100 to the user. For instance, the contextual update module 140 can select a subsection of the content 124 based on visibility of the subsection in the display module 120. The contextual update module 140 can then analyze the selected subsection to identify one or more parameters. The parameters can drive the contextual update of the geographic imagery. Once the one or more parameters are identified, the contextual update module 140 can provide commands for updating the geographic imagery in accordance with the identified parameters.

A particular subsection of the content 124 can be selected by the content module 140 based on visibility of the subsection by implementing executable code configured to identify subsections based on visibility. For instance, in one implementation, the content 124 can be provided as a web document specified in a markup language, such as HTML, XML, or other markup language. The web document can divide content 124 into subsections using markup language tags, such as div tags. The contextual update module 140 can receive outputs from executable code, such as Javascript code, executed in conjunction with the display of the content 124. The executable code can provide an assessment of the visibility of the subsections in the content 124 in the display element 120. The contextual update module 140 can then select a particular subsection based on the output to provide contextual updates to the geographic imagery 130.

In one embodiment, the contextual update module 140 can select a subsection of the content identified to be within a view area 126 of the display element 120. For instance, executable code can assess the current screen coordinates (e.g. y-coordinates) of the various subsections (as defined by markup language tags) relative to a set of threshold screen coordinates associated with the view area 126. If a particular subsection falls within the threshold screen coordinates associated with view area 126, the subsection can be selected by the contextual update module 140 for providing contextual updates to the geographic imagery 130.

In another embodiment, the contextual update module 140 can detect the most prominently visible subsection of content 124 in the display element 120. For instance, the contextual update module 140 can receive updates from a polling module, such as a Javascript based polling module, that detects which subsection (e.g. as defined by markup language tags) currently takes up the most space in the display element 120. The detected subsection can be selected by the contextual update module 140 for providing contextual updates of the geographic imagery 130.

After a particular subsection has been selected, the contextual update module 140 can analyze the selected subsection to identify one or more parameters. The parameters drive the updates to the geographic imagery 130. In one implementation, the parameters can be geographic keywords provided in the subsection. For instance, a keyword extraction technique can be used to identify keywords associated with specific geographic locations and other geographic objects discussed in the selected subsection. Any suitable keyword extraction technique can be used to identify geographic keywords in the subsection. For example, the subsection can be analyzed using data mining techniques to identify specific predefined geographic keywords in the subsection. The specific predefined geographic keywords can be maintained in a data compilation of geographic keywords. Once identified, the keywords can be used by the contextual update module 140 to update the geographic imagery 130 to display information associated with one or more of the identified geographic keywords.

In another implementation, the parameters can be executable code, such as Javascript code, that is associated with the particular selected subsection. In particular, executable code can be previously associated with each of the subsections of the content 124 presented in the display element 120. The executable code can specify the updates to the geographic imagery 130. The contextual update module 140 can analyze a selected subsection to identify the executable code associated with the particular subsection. The contextual update module 140 can then implement the executable code associated with the selected subsection to update the display of geographic imagery 130 in accordance with the executable code.

The contextual update module 140 can update the geographic imagery 130, for instance, by adjusting the camera view associated with the geographic imagery 130. In addition or in the alternative, the contextual update module 140 can display or hide vectors, overlays, geographic data layers, and/or other information in conjunction with the geographic imagery 130. In this way, the contextual update module 140 can update the geographic imagery 130 based on the context of the content 124 presented in the display element 120.

### Flow Diagram of an Exemplary Method for Providing Contextual Updates to Geographic Imagery

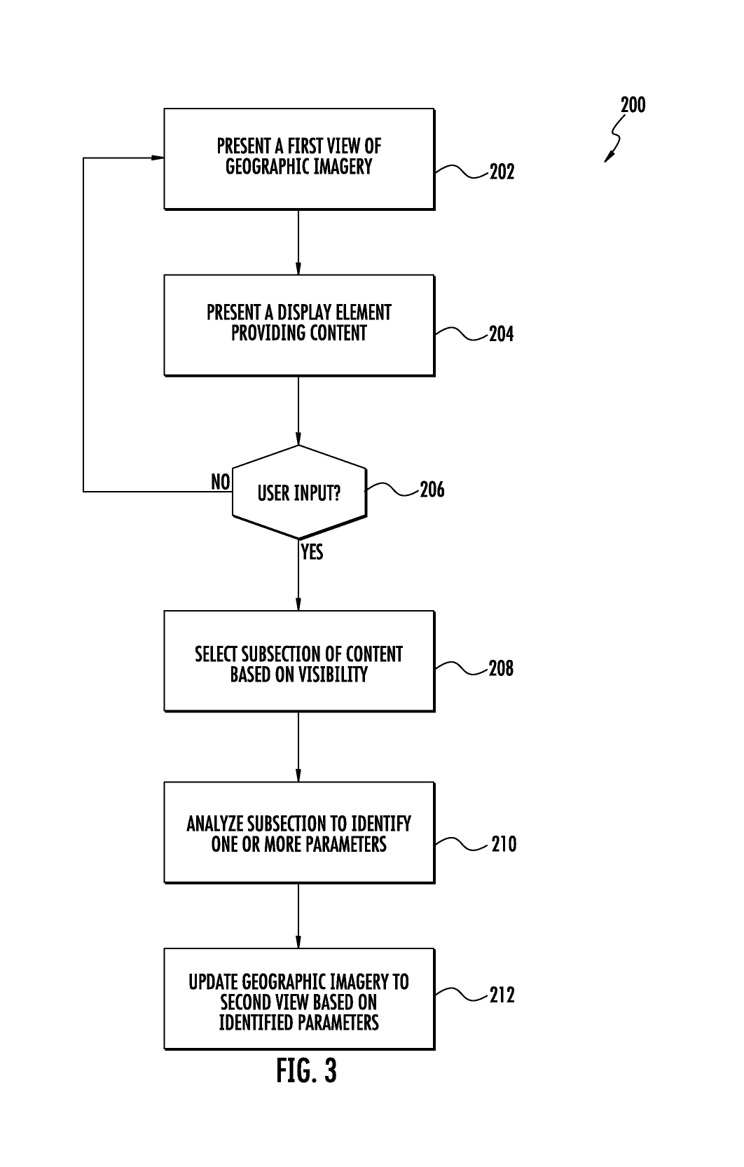

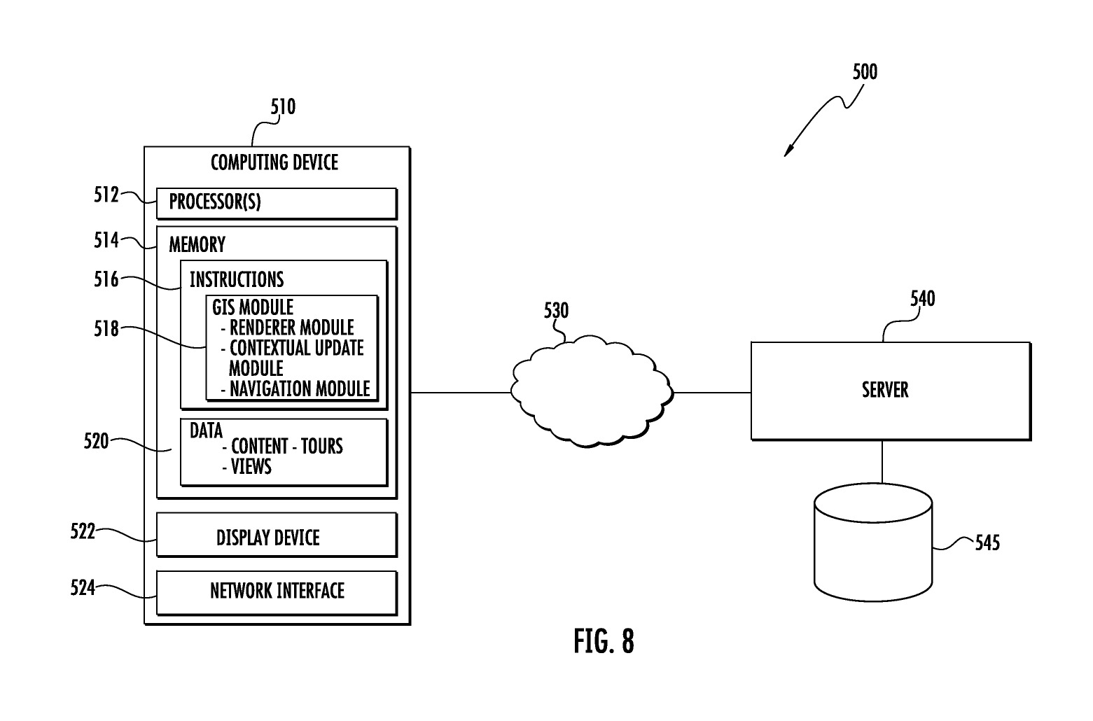

FIG. 3 depicts a flow diagram of an exemplary computer-implemented method of providing contextual updates to geographic imagery according to an exemplary embodiment of the present disclosure. FIG. 3 can be implemented using any suitable computing system, such as the computing system depicted in FIG. 8. In addition, FIG. 3 depicts steps performed in a particular order for purposes of illustration and discussion. Those of ordinary skill in the art, using the disclosures provided herein, will understand that various steps of the methods discussed herein can be omitted, rearranged, combined and/or adapted in various ways.

At (202), a first view of geographic imagery is presented. For instance, a first view of geographic imagery 130 can be presented in a user interface 100 on the display of computing device 110 of FIG. 1. The geographic imagery can provide a two-dimensional or three-dimensional representation of a geographic area of interest. At (204) of FIG. 3, a display element providing content associated with the geographic imagery can be presented in conjunction with the geographic imagery. For instance, the display element 120 providing content 124 associated with the geographic imagery 130 can be presented in the user interface 100 of FIG. 1. In one implementation, the display element can be presented in response to a user input directed to a point of interest in the geographic imagery. The display element can provide content associated with the point of interest.

The content can include a plurality of subsections. Each subsection can provide different information associated with the geographic imagery. Certain of the subsections can be visible in the display element while other subsections may not be visible. For instance, referring to FIG. 1, the content 123 can include visible subsections such as Subsection A, Subsection B, and Subsection C. The content 124 can also include subsections that are not visible in the display element 120, such as Subsection D, Subsection E, and so forth

At (206) of FIG. 3, it can be determined whether a user input directed to the display element adjusting the visibility of the content in the display element has been received. For instance, it can be determined whether a user input directed to the display element 120 adjusting the visibility of the subsections provided in the display element 120 has been received. An example user input adjusting the visibility of content 124 in the display element 120 can include scrolling the content 120 in the display element using, for instance, the scroll tool 125. If a user input adjusting the visibility of the content is received, the method can provide a contextual update of the geographic imagery based on the visibility of the content in the display element as set forth in more detail below. Otherwise, the method can continue to display the first view of geographic imagery as shown at (202) of FIG. 3.

If a user input adjusting the visibility of the content is received, the method can select a subsection of the content displayed in the display element based on the visibility of the subsection (208). For instance, one of the subsections of the content 124 depicted in the display element 120 of FIG. 1 can be selected based on visibility. As discussed above, the subsection can be selected by identifying the subsection within a particular view region of the display element. Alternatively, a subsection can be selected by detecting the most prominently visible subsection displayed in the display element.

Once a subsection has been selected, the subsection can be analyzed to identify one or more parameters as shown at (210) of FIG. 3. The one or more parameters can be geographic keywords provided in the subsections. Alternatively or in addition, the one or more parameters can be executable code associated with the particular subsection that can be used to trigger updates to the geographic imagery.

At (212), the method includes updating the geographic imagery to a second view based on the identified parameters. For instance, the geographic imagery can be updated to display locations and/or information associated with geographic keywords identified from the subsection. The geographic imagery can also be updated in accordance with executable code associated with the geographic imagery. The geographic imagery can be updated in accordance with the identified parameters to provide different a different camera view of a geographic area. The geographic imagery can also be updated in accordance with the identified parameters to display or hide vectors, overlays, geographic data layers or other information associated with the geographic imagery. A smooth animation can be provided between the different views of the geographic imagery to provide a visually pleasing transition for the user. In addition, the relevant portions of the geographic imagery can be centered on the portion of the display that is not occluded by the display element so that the relevant information presented in the geographic imagery is readily visible by the user.

### Exemplary Method for Providing a Virtual Tour Using Contextual Updates to Geographic Imagery

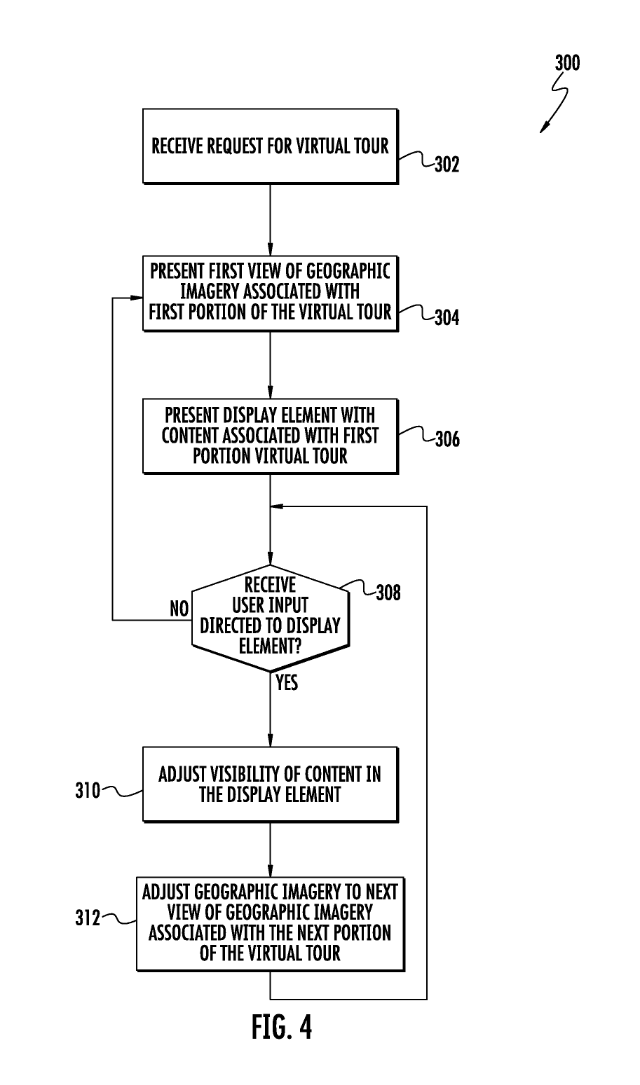

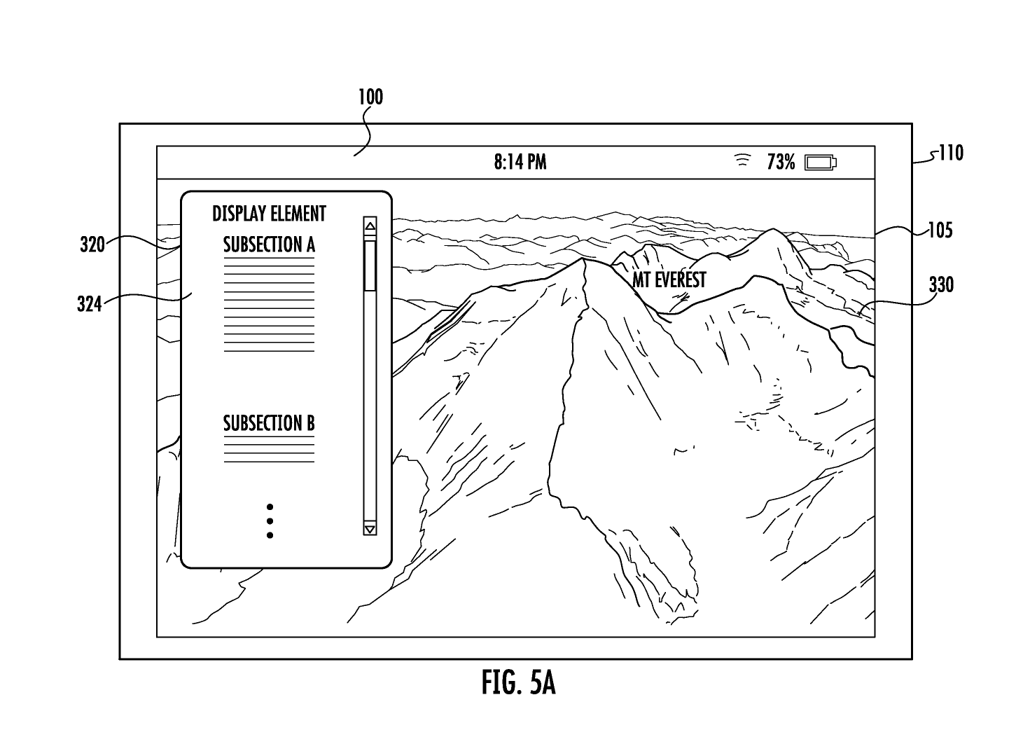

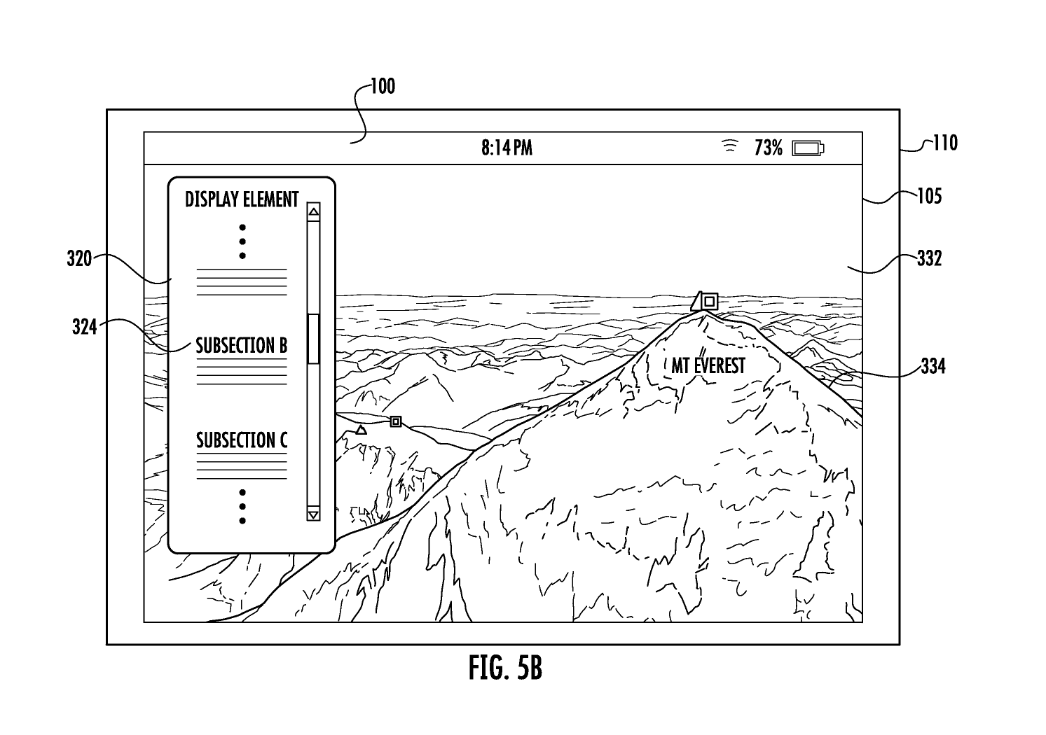

One exemplary application of providing contextual updates to geographic imagery is directed to providing virtual tours of a geographic area in a geographic information system. FIG. 4 depicts a flow diagram of an exemplary method (300) for providing a virtual tour according to an exemplary embodiment of the present disclosure. The method (300) can be implemented using any suitable computing device, such as the computing device 110 depicted in FIGS. 5A and 5B.

At (302) of FIG. 4, a request for a virtual tour can be received. For instance, a user can provide a user input requesting a virtual tour of a geographic area. In response to the user input, a virtual tour of a geographic area can be initialized. The virtual tour can provide a sequence of events that updates the view of the geographic imagery with vectors, overlays, geographic data layers, different camera views, etc., as the virtual tour progresses.

At (304), geographic imagery associated with a first portion of the virtual tour can be presented to the user (304). For example, as shown in FIG. 5A, a first view of geographic imagery 330 can be presented in a user interface 100 on a display 105 of the computing device 110. The first view of geographic imagery 330 can be associated with a first portion of the virtual tour, such as the start of the virtual tour. The geographic imagery 330 depicted in FIG. 5A is three-dimensional imagery associated with Mount Everest. Other suitable geographic imagery, such as two-dimensional geographic imagery, can be provided without deviating from the scope of the present disclosure.

Referring back to FIG. 4, a display element can be presented providing content associated with the virtual tour (306). For instance, as shown in FIG. 5A, a display element 320 can be presented in conjunction with the geographic imagery 330. The display element 320 can provide content 324, such as text content, detailing aspects of the virtual tour. The content 324 can include multiple subsections (e.g. paragraphs). Each subsection can detail different information associated with the virtual tour. For instance, content 324 can include Subsection A detailing aspects associated with a first portion of the virtual tour. Content 324 can also include Subsection B detailing aspects associated with a second portion of the virtual tour. The content 324 can include yet other subsections (not yet visible in display element 320) detailing aspects associated with additional portions of the virtual tour. The content of Subsection A can be associated with the first view of the geographic imagery 330 depicted in FIG 5A.

At (308) of FIG. 4, it can be determined whether a user input adjusting the visibility of the content in the display element has been received. For instance, it can be determined whether a user has provided an input (e.g. a scroll input) directed the display element 320 of FIG. 5A that adjusts the visibility of the subsections provided in the display element 320. If no user input is received, the method continues to present geographic imagery associated with the first portion of the virtual tour as shown at (304) of FIG. 4.

If a suitable user input is received, the method continues to (310) where the visibility of the content in the display element is adjusted in response to the user input. The visibility of the content can be adjusted such that the subsection associated with the next portion of the virtual tour is more prominently displayed in the display element. For instance, FIG. 5B depicts the visibility of the content 324 in the display element 320 in response to the user input (e.g. a scroll input). In particular, a portion of Subsection A of the content 324 is no longer visible in the display element 320. Subsection B is more prominently visible in the display element 320. In addition, a portion of Subsection C has become visible in the display element 320.

In further response to the user input, the method can include adjusting the geographic imagery to present the next view of the geographic imagery associated with the next portion of the virtual tour as shown at (312) of FIG. 4. In particular, the next subsection of the content presented in the display element can be identified as the most prominently visible subsection in the display element. This subsection can be analyzed to identify one or more parameters, such as executable code, associated with the subsection. The parameters can be used to update the geographic imagery to present the next view of the geographic imagery associated with the next portion of the virtual tour.

For instance, as shown in FIG. 5B, Subsection B can be identified as the most prominently visible subsection in the display element 320. Subsection B can be analyzed to identify executable code associated with Subsection B. This executable code can be implemented to trigger the adjustment of the geographic imagery to present the next view of geographic imagery 332 associated with Subsection B. The next view of geographic imagery can include a different camera view of the geographic area in addition to different vectors, overlays, geographic data layers, and other information. For instance, as shown in FIG. 5B, the next view of geographic imagery 332 depicts Mt. Everest from a different camera view and also presents additional overlays 334 and other information that were not depicted in the first view of geographic imagery 330 shown in FIG. 5A. A smooth animation can be provided between the different views of the geographic imagery to provide a visually pleasing transition between the different views to the user.

As shown in FIG. 4, the user can progress to the next portion of the virtual tour by providing additional user input adjusting the view of the content presented in the display element. For instance, the user can scroll the content 324 presented in the display element 320 of FIG. 5B such that additional subsections become more prominently visible in the display element 320. In this manner, the user can drive the virtual tour by scanning through the content presented in the display element 320.

### Exemplary Method for Providing Travel Directions Using Contextual Updates to Geographic Imagery

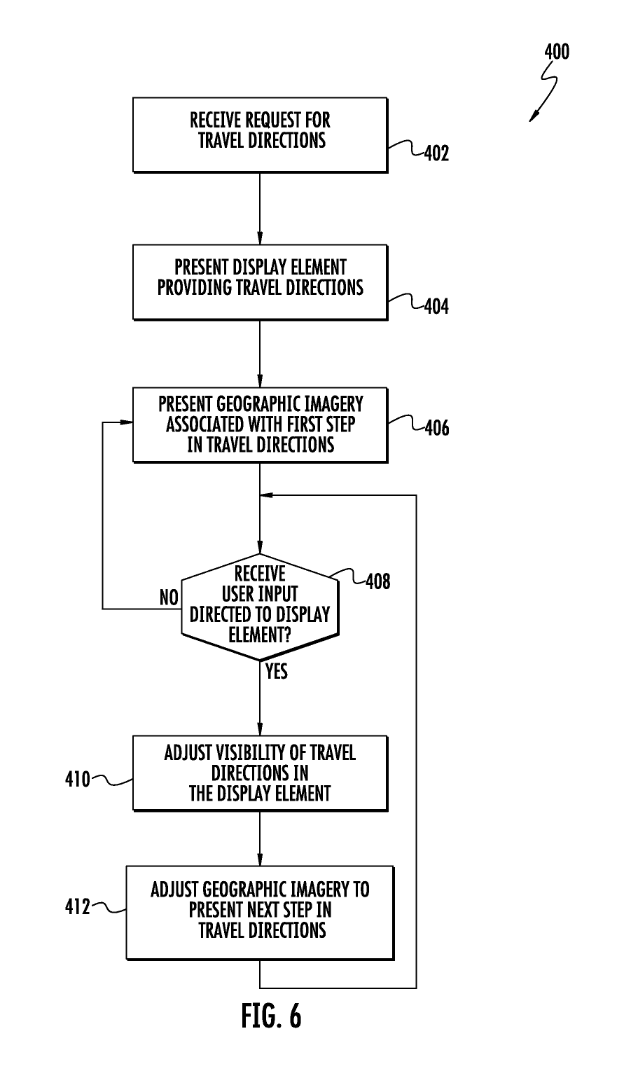

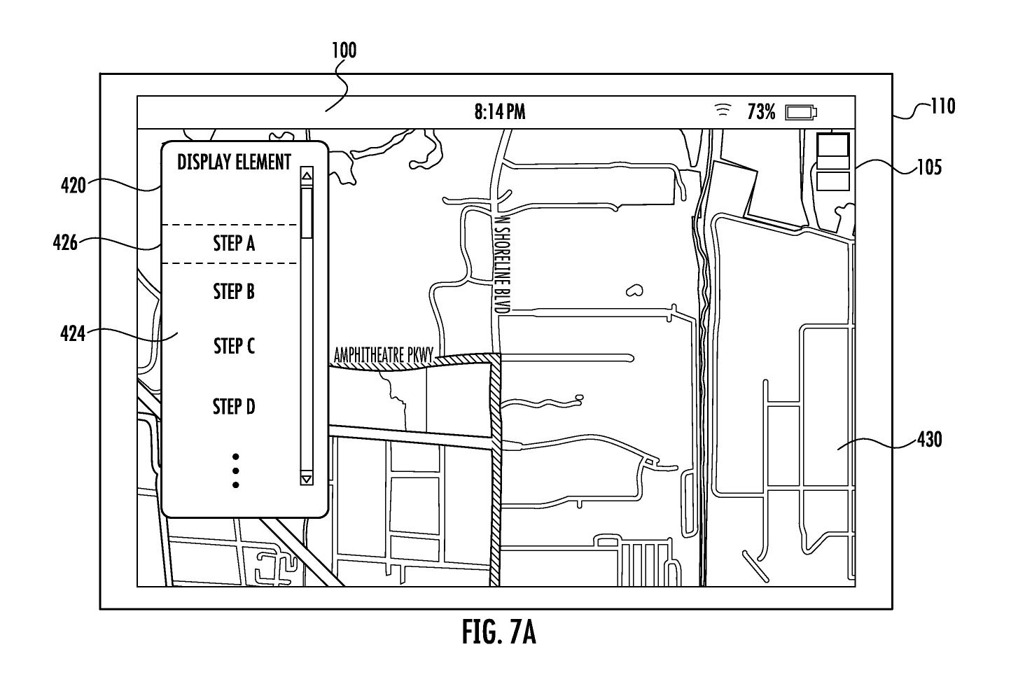

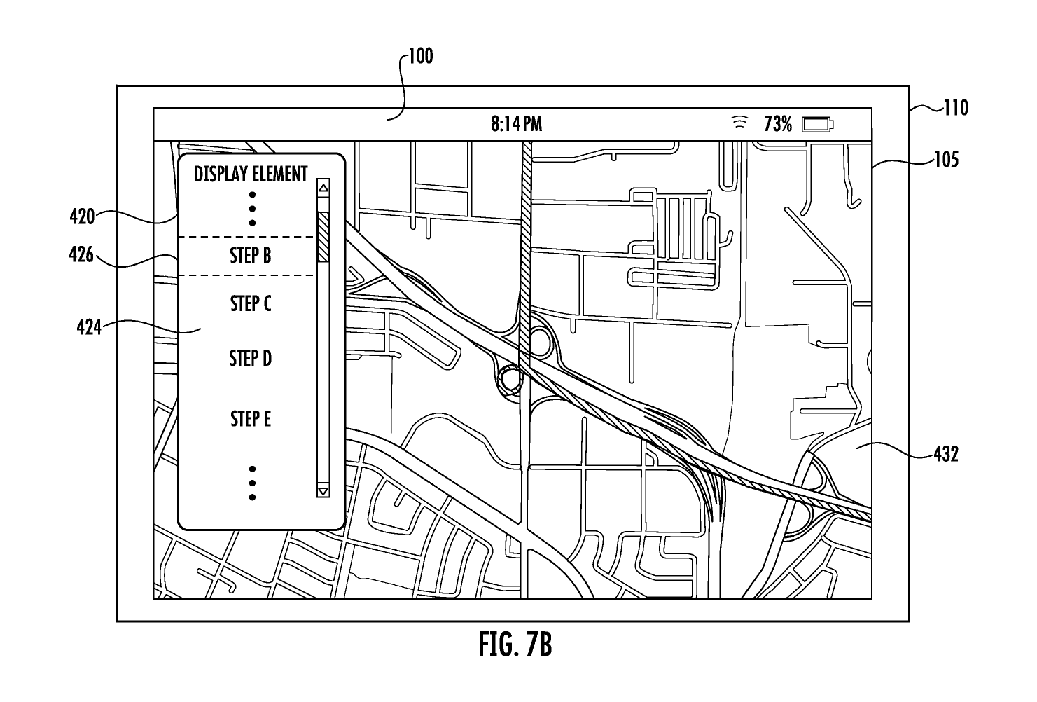

Another exemplary application of providing contextual updates to geographic imagery is directed to providing travel directions. FIG. 6 depicts a flow diagram of an exemplary method (400) for providing a travel directions according to an exemplary embodiment of the present disclosure. The method (400) can be implemented using any suitable computing device, such as the computing device 110 depicted in FIGS. 7A and 7B.

At (402) of FIG. 6, a request for travel directions for a travel objective can be received. For instance, a user can provide a user input requesting travel directions between an origin and a destination. In response to the user input, a travel route can be calculated between the origin and the destination. Travel directions associated with the travel route can then be presented in a display element to the user (404).

For example, as shown in FIG. 7A, a display element 420 can be presented in a user interface 100. The display element 420 can provide content 424 that includes travel directions for the travel route. The content 424 can include multiple subsections. Each subsection can detail different information associated with a different step in the travel directions. For instance, content 424 can include Step A detailing aspects associated with a first step in the travel directions. Content 424 can also include Step B detailing aspects associated with the next step in the travel directions. The content 424 can include yet other steps in the travel directions (e.g. Step C and Step D) including steps that are not yet visible in the display element 420.

Referring back to FIG. 6 at (406), the method can include presenting geographic imagery associated with the first step in the travel directions. For instance, the user interface 100 of FIG. 7A can present geographic imagery 430 associated with the first step in the travel directions. In particular, it can be identified that content associated with Step A is located in a view region 426 of the display element 420. Accordingly, geographic imagery 330 depicting Step A in the travel directions can be presented in conjunction with the display element 420.

At (408) of FIG. 6, it can be determined whether a user input adjusting the visibility of the content in the display element has been received. For instance, it can be determined whether a user has provided an input (e.g. a scroll input) directed the display element 420 of FIG. 7 A that adjusts the visibility of the travel directions provided in the display element 420. If no user input is received, the method continues to present geographic imagery associated with the first step in the travel directions as shown at (406) of FIG. 6.

If a suitable user input is received, the method continues to (410) where the visibility of the travel directions in the display element can be adjusted in response to the user input. The visibility of the content can be adjusted such that the information associated with the next step in the travel directions is within the view region of the display element. For instance, FIG. 7B depicts the visibility of the travel directions in the display element 420 in response to the user input (e.g. a scroll input). In particular, a Step A is no longer visible in the display element 320. Step B is now located in the view region 426 of the display element 420.

In further response to the user input, the method can include adjusting the geographic imagery to present the next step in the travel directions as shown at (412) of FIG. 6. In particular, the next step in the travel directions can be identified to be within a view region of the display element. This step can be analyzed to identify one or more parameters, such as executable code, associated with the step. The parameters can be used to update the geographic imagery to present the next step in the travel directions to the user.

For instance, as shown in FIG. 7B, Step B can be identified as being within the view region 426. Step B can be analyzed to identify executable code associated with Step B. This executable code can be implemented to trigger the adjustment of the geographic imagery to present geographic imagery 332 associated with Step B in the travel directions.

As shown in FIG. 6, the user can progress to the next step in the travel directions by providing additional user input adjusting the visibility of travel directions presented in the display element. For instance, the user can scroll the travel directions presented in the display element 420 of FIG. 7B such that different travel steps are located in the view region. In this manner, the user can progress through the travel directions for a travel objective using simple interactions with the display element 420.

### Exemplary Computer Based System for Providing Contextual Updates to Geographic Imagery

FIG. 8 depicts an exemplary computing system 500 that can be used to implement the systems and methods for contextual update of geographic imagery according to exemplary aspects of the present disclosure. The system 500 includes a computing device 510. The computing device 510 can be any machine capable of performing calculations automatically. For instance, the computing device can include a general purpose computer, special purpose computer, laptop, desktop, smartphone, tablet, cell phone, mobile device, integrated circuit, or other suitable computing device.

The computing device 510 can have a processor(s) 512 and a memory 514. The computing device 510 can also include a network interface 524 used to communicate with remote computing devices over a network 530. In one exemplary implementation, the computing device 510 can be in communication with a server 540, such as a web server, used to host a geographic information system, such as the Google Maps™ and/or the Google Earth™ geographic information systems provided by Google Inc.

The processor(s) 512 can be any suitable processing device, such as a microprocessor. The memory 514 can include any suitable computer-readable medium or media, including, but not limited to, RAM, ROM, hard drives, flash drives, magnetic or optical media, or other memory devices. The memory 514 can store information accessible by processor(s) 512, including instructions 516 that can be executed by processor(s) 512. The instructions 516 can be any set of instructions that when executed by the processor(s) 512, cause the processor(s) 512 to perform operations. For instance, the instructions 516 can be executed by the processor(s) 512 to implement a geographic information system (GIS) module 518. The GIS module 518 can allow a user of the computing device 510 to interact with a geographic information system hosted by, for instance, the server 540.

The GIS module 518 can include, among other components, a contextual update module, a renderer module, and a navigation module. The navigation module can receive user input regarding a desired view of geographic imagery and uses the user input to construct a view specification for a virtual camera. The renderer module uses the view specification to determine what data to draw and draws the data. If the renderer module needs to draw data that the computing device 510 does not have, the renderer module can send a request to the server 540 for the data over the network 530. The contextual update module can be used to provide contextual updates of geographic imagery according to exemplary aspects of the present disclosure.

Memory 514 can also include data 518 that can be retrieved, manipulated, created, or stored by processor(s) 512. For instance, memory 514 can store content for presentation in association with geographic imagery, data associated with virtual tours, data associated with different views of geographic imagery and other information that is used by the GIS module. Processor(s) 512 can use this data to present geographic imagery and content associated with the geographic imagery to a user.

Computing device 510 can include or can be coupled to one or more input/output devices. Input devices may correspond to one or more peripheral devices configured to allow a user to interact with the computing device. One exemplary input device can be a touch interface (e.g. a touch screen or touchpad) that allows a user to interact with the geographic information system using touch commands. Output device can correspond to a device used to provide information to a user. One exemplary output device includes a display 522 for presenting the user interface including the geographic imagery and display element presenting information associated with the geographic imagery. The computing device 510 can include or be coupled to other input/output devices, such as a keyboard, microphone, mouse, audio system, printer, and/or other suitable input/output devices.

The server 540 can host the geographic information system. The server 540 can be configured to exchange data with the computing device 510 over the network 530. For instance, responsive to a request for information, the server 540 can encode data in one or more data files and provide the data files to the computing device 510 over the network 530. Similar to the computing device 510, the server 540 can include a processor(s) and a memory. The server 540 can also include or be in communication with one or more databases 545. Database(s) 545 can be connected to the server 540 by a high bandwidth LAN or WAN, or can also be connected to server 540 through network 530. The database 545 can be split up so that it is located in multiple locales.

The network 530 can be any type of communications network, such as a local area network (e.g. intranet), wide area network (e.g. Internet), or some combination thereof. The network 530 can also include a direct connection between a computing device 510 and the server 540. In general, communication between the server 540 and a computing device 510 can be carried via network interface 524 using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method of presenting geographic imagery, comprising:
presenting, by one or more computing devices, a first view of the geographic imagery in a user interface on a display of a computing device;
presenting, by the one or more computing devices, a display element in conjunction with the geographic imagery, the display element providing text content associated with the geographic imagery, the text content having a plurality of subsections of text content, at least one of the subsections being visible in the display element;
receiving, by the one or more computing devices, a user scroll input directed to the display element scrolling the visibility of one or more subsections of text content in the display element; and
in response to the user scroll input scrolling the visibility of one or more subsections, performing operations comprising:
identifying, by the one or more computing devices, subsection of text content displayed in the display element based at least in part on the visibility of the subsection as a result of the scroll input;
analyzing by the one or more computing devices, the identified subsection to identity one or more parameters associated with fee text content in the identified subsection; and
adjusting, by the one or more computing devices, the geographic imagery in the user interface to present a second view of the geographic imagery based on the identified parameters associated with the text content in the identified subsection.

2. The computer-implemented method of claim 1, wherein the display element is provided in response to a user interaction directed to a point of interest, the content being associated with the point of interest.

3. The computer-implemented method of claim 1, wherein the display element is a text balloon or a text frame presented in conjunction with the geographic imagery.

4. (canceled)

5. The computer-implemented method of claim 1, wherein the content is a single page web document.

6. (canceled)

7. The computer-implemented method of claim 1, wherein identifying a subsection displayed in the display element based on the visibility of the subsection comprises identifying a subsection presented within a view area of the display element.

8. The computer-implemented method of claim 1, wherein identifying a subsection displayed in the display element based on the visibility of the subsection comprises:
detecting, by the one or more computing devices, the most prominently visible subsection in the display element; and
identifying, by the one or more computing devices, the most prominently visible subsection as the identified subsection.

9. The computer-implemented method of claim 1, wherein the one or more parameters comprise geographic keywords provided in the identified subsection.

10. The computer-implemented method of claim 1, wherein the one or more parameters comprise executable code associated with the identified subsection, the executable code triggering the adjusting of the geographic imagery in the user interface to the second view of the geographic imagery.

11. The computer-implemented method of claim 1, wherein adjusting the display of the geographic imagery in the user interface to a second view of the geographic imagery comprises adjusting a camera view of the geographic imagery.

12. The computer-implemented method of claim 1, wherein adjusting the display of the geographic imagery in the user interface to a second view of the geographic imagery comprises displaying or hiding one or more overlays, vectors, or geographic data layers in conjunction with the geographic imagery.

13. The computer-implemented method of claim 1, wherein the content is associated with a virtual tour of a geographic area.

14. The computer-implemented method of claim 12, wherein adjusting the display of the geographic imagery in the user interface to the second view comprises adjusting the display of geographic imagery to present a portion of the virtual tour.

15. The computer-implemented method of claim 1, wherein the content provided in the display element is associated with travel directions.

16. The computer-implemented method of claim 15, wherein adjusting the display of the geographic imagery In the user interface to the second view comprises adjusting the display of geographic imagery to present a portion of the travel directions.

17. A computing device comprising a display device, one or more processors, and at least one computer-readable medium, the computer-readable medium storing instructions that when executed by the processor to perform operations, the operations comprising:
presenting a first view of the geographic imagery in a user interface on the display device;
presenting a display element in conjunction with the geographic imagery, the display element providing text content associated with the geographic imagery, the text content having a plurality of subsections of text content, at least one of the subsections being visible in the display element;
receiving a user scroll input directed to the display element scrolling the content in the display element to adjust the visibility of one or more subsections of text content in the display element; and
responsive to the user scroll input, identifying a subsection displayed in the display element based on the visibility of the subsection as a result of the scroll input; analyzing the identified subsection to identify one or more parameters associated with the text content in the identified subsection; and adjusting the geographic imagery in the user interface to present a second view of the geographic imagery based on the identified parameters associated with the text content in the identified subsection.

18. The computing device of claim 17, wherein the operation of adjusting the display of the geographic imagery in the user interface to a second view of the geographic imagery comprises adjusting a camera view of the geographic imagery.

19. The computer device of claim 17, wherein the operation of adjusting the display of the geographic imagery in the user interface to a second view of the geographic imagery comprises displaying or hiding one or more overlays, vectors, or geographic data layers in conjunction with the geographic imagery.

20. A computer-implemented method of providing a virtual tour of geographic imagery of a geographic area, the method comprising:
receiving, by one or more computing devices, a user input requesting a virtual tour of the geographic area;
presenting, by the one or more computing devices, a first view of geographic imagery in a user interface on a display device, the first view of the geographic imagery associated with a first, portion of the virtual tour;
presenting, by the one or more computing devices, a display element in conjunction with the geographic imagery, the display element providing text content associated with the virtual tour, the text content comprising a first subsection and a second subsection, the first subsection associated with text content corresponding to the first portion of the virtual tour, the second subsection associated with a text content corresponding second portion of the virtual tour, the first subsection being visible in the display element;
receiving, by the one or more computing devices, a user scroll input directed to the display element scrolling the visibility of the first and second subsections in the display element such that the second subsection becomes visible in the display element; and
in response to the user input, performing operations comprising:
analyzing, by the one or more computing devices, the second subsection to identify one or more parameters associated with text content in the second subsection; and
adjusting, by the one or more computing devices, the geographic imagery in the user interface to present a second view of the geographic imagery based on the identified parameters associated with the text content in the second subsection, the second view of the geographic imagery associated with the second portion of the virtual tour.
